(19) United States
(12) Patent Application Publication
(10) Pub. No.: US 2006/0214134 A1
(43) Pub. Date: Sep. 28, 2006

(54) Luminescent glass article and method of manufacturing the same

(76) Inventors: Noriaki Masuda, Shiga-Ken (JP); Hiroshi Oshima, Shiga-Ken (JP); Takehiro Shibuya, Shiga-Ken (JP)

Correspondence Address: JC Patents Inc, Suite 250, 4 Venture, Irvine, CA, 92618, US

(21) Appl. No.: 10/550,867

(22) PCT Filed: Mar. 31, 2004
(86) PCT No.: PCT/JP04/04722

§ 371 Date: Sep. 22, 2005

(30) Foreign Application Priority Data
Apr. 1, 2003 (JP) 2003097960
Sep. 29, 2003 (JP) 2003337317
Mar. 22, 2004 (JP) 2004083270

(51) Int. Cl. C04B 35/14; C09K 11/08

(52) U.S. Cl. 252/301.4 F; 264/1.22; 264/332

(57) ABSTRACT

A luminescent glass article of the present invention includes a luminescent substance dispersed uniformly in glass, in which: light transmittance is 20 to 90% at a thickness of 10 mm; and an initial luminescence intensity just after irradiation of light of 1,000 lux for 20 min is 200 to 4,000 mcd/m².

### TECHNICAL FIELD

The present invention relates to a luminescent glass article mainly used as pavements, building covering materials, building interior materials, art objects, guide lights, sidewalk lights, or foot lights, and to a method of manufacturing the same.

### BACKGROUND ART

Recently, numerous glass articles have been used as building materials with diversification of building design. In particular, cases employing building glass articles having improved functionality or decorative properties (design properties) using to light have increased lately.

However, pavements, building covering materials, building interior materials, art objects, guide lights in dark places requiring no high intensity illumination, illumination for lighting the sides of a sidewalk, foot lights provided for recognition the presence of a wall or steps, and the like which require a light source, such as an electric bulb or a fluorescent lamp, have limited design flexibility, and require maintenance. A building material, a so-called luminescent glass article, capable of absorbing ultraviolet light or visible light in sunlight or the like replaces the above-described light sources by discharging energy thereof as light emissions for a long period of time. The luminescent glass article requires no maintenance, can enhance design flexibility, and uses no electric power. Thus this glass article has attracted attention from the viewpoint of energy-savings.

There is proposed a luminescent glass article in which glass having a specific composition is capable of absorbing ultraviolet light or visible light for light emission (see Patent Document 1, for example).

Further, there is proposed a luminescent glass article prepared by mixing glass powder particles with a luminescent substance and sintering the mixture (see Patent Document 2, for example).

[Patent Document 1] JP-A-2000-63145

[Patent Document 2] JP-A-11-293238

Meanwhile, the glass article disclosed in Patent Document 1, in which the glass itself exhibits luminescence, emits its own light. For emission of light of various colors, glass having a composition for each color must be manufactured, and the manufacture of glass articles having different luminescent colors has high costs.

The luminescent glass article described in Patent Document 2 contains as much as 20 wt % of an expensive luminescent substance, to thereby increase cost and degrade mechanical strength due to poor sintering property.

### DISCLOSURE OF THE INVENTION

It is an object of the present invention to provide: a luminescent glass article which has high mechanical strength, which provides sufficient luminescence intensity, and which can be manufactured at a low cost; and a method of manufacturing the same.

The inventors of the present invention have conducted intensive studies, and have found that the above object can be attained by: incorporating an appropriate amount of a luminescent substance in glass to provide light transmission and allowing light emission of a luminescent substance present not only in a surface layer but also inside the glass article. Thus, the inventors have proposed the present invention.

A luminescent glass article of the present invention is achieved by including a luminescent substance dispersed uniformly in glass, in which: a light transmittance is 20 to 90% at a thickness of 10 mm, and the initial luminescence intensity just after irradiation of light of 1,000 lux for 20 min is 200 to 4,000 mcd/m².

Further, a luminescent glass article of the present invention is characterized by including a luminescent substance dispersed uniformly in glass, in which a content of the luminescent substance is 0.1 to 5 mass %.

A method of manufacturing a luminescent glass article of the present invention is achieved by: mixing a plurality of glass particles and a luminescent substance; filling the mixture into a refractory vessel; and subjecting the mixture to heat treatment for sintering.

The luminescent glass article of the present invention has a light transmittance of 20% to 90% at a thickness of 10 mm, and has sufficient light transmission. Thus, light reaches into the luminescent glass article, and the luminescent substance present thereinside can emit light, which reaches the surface of the luminescent glass article. The initial luminescence intensity just after irradiation of light of 1,000 lux for 20 min is 200 to 4,000 mcd/m². The light transmittance refers to a value obtained by: cutting the luminescent glass article into a sample of 50×50×10 mm; subjecting both surfaces of the cut-out piece to optical polishing to prepare a plate sample; adjusting light directly illuminated from a light source of a fluorescent lamp to an illuminance meter at an illuminance of 1,000 lux; measuring an illuminance (lux) 10 times with the sample placed between the fluorescent lamp and the illuminance meter; and dividing the average value thereof by 1,000 lux and multiplying the quotient by 100.

The light transmittance is in a range of preferably 30 to 80%, and more preferably 40 to 65%.

The initial luminescence intensity is preferably in a range of 250 to 2,500 mcd/m², and preferably in the 300 to 1,500 mcd/m².

The luminescent glass article of the present invention includes a luminescent substance dispersed uniformly in glass and a content of the luminescent substance that is 0.1 to 5 wt %. Thus, the luminescent glass article of the present invention has high mechanical strength, can provide sufficient luminescence intensity, and can be manufactured at low cost.

That is the luminescent glass article of the present invention that has a content of the luminescent substance of 0.1 to 5 wt %. The luminescent substance does not inhibit sintering of the glass. Thus, the luminescent glass article has high mechanical strength, and thus can be formed into a plate or block. A small content of the luminescent substance means luminescent glass article can be manufactured at a low cost.

Luminescent substances of different luminescent colors may be used, or glass may contain colorants uniformly. Thus, the luminescent glass article can emit light of a desired color, and luminescent glass articles having different luminescent colors can be manufactured at a low cost.

### BEST MODE FOR CARRYING OUT THE INVENTION

A luminescent glass article of the present invention preferably has a luminescent substance content of 0.1 to 5 wt %. If the content of the luminescent substance is less than 0.1 wt %, sufficient luminescence intensity cannot be obtained. If the content of the luminescent substance is more than 5 wt %, fluidity of glass degrades and fusion bonding of the glass is inhibited. Sufficient mechanical strength cannot be obtained, and sufficient light transmission cannot be obtained. Thus, luminescence intensity is hardly improved, even with further addition of the luminescent substance. The luminescent substance is expensive, and thus further addition is not preferable cost-wise. The preferable content range of the luminescent substance is 0.3 to 4 mass %, preferably 0.5 to 2.9 mass %, and even better is 1.1 to 2.8 mass %.

The luminescent glass article of the present invention preferably has the softening point of glass, which is its base material, 1,100° C. or lower. If a glass softening point is higher than 1,100° C., glass forming requires a temperature higher than 1,200° C. Under such temperature conditions, the forming vessel for the glass article is liable to soften and deform and the glass article is difficult to form. Further, a luminescent material degrades, and luminescence is liable to degrade. The glass softening point is in a range of preferably 1,000° C. or lower, and more preferably 900° C. or lower.

Further, the luminescent glass article of the present invention preferably has a glass softening point of 650° C. or higher for high mechanical strength and high hardness. That is, a glass softening point of 650° C. or higher provides strong interatomic bonding and high mechanical strength. The luminescent glass article is hard to break, has high hardness, and is hard to damage on the surface. The glass softening point is preferably 700° C. or higher.

The luminescent glass article of the present invention is preferably composed soda-lime glass, borosilicate glass, aluminosilicate glass, or aluminoborosilicate glass to have sufficient chemical resistance and mechanical strength. To be specific, the soda-lime glass is preferably a glass containing 65 to 75% SiO₂, 0.5 to 3% Al₂O₃, 0 to 7% B₂O₃, 1 to 4% MgO, 5 to 10% CaO, 12 to 15% Na₂O, and 0 to 3% K₂O in mass %. The borosilicate glass is preferably a glass containing 65 to 75% SiO₂, 3 to 7% Al₂O₃, 10 to 15% B₂O₃, 0 to 3% CaO, 0 to 5% Li₂O, 0 to 8% Na₂O, and 0 to 4% K₂O in mass %. The aluminosilicate glass is preferably a glass containing 50 to 65% SiO₂, 15 to 25% Al₂O₃, 2 to 5% B₂O₃, 8 to 15% MgO, 3 to 7% CaO, 0 to 7% SrO, 0 to 4% BaO, and 0 to 2% Na₂O in mass %. The aluminoborosilicate glass is preferably a glass containing 50 to 65% SiO₂, 10 to 20% Al₂O₃, 7 to 12% B₂O₃, 0 to 5% MgO, 0 to 7% CaO, 0 to 7% SrO, 0 to 4% BaO, and 0 to 3% Na₂O in mass %.

The luminescent glass article of the present invention includes a luminescent substance composed of one or two or more compounds selected from the group consisting of: MAl₂O₄ or M₄Al₁₄O₂₅ (where M represents Ca, Sr, or Ba) containing trace amounts of one or two or more rare earth metal elements selected from the group consisting of Eu, Ce, Pr, Nd, Sm, Tb, Dy, Ho, Er, Tm, Yb, and Lu; Y₂O₂S containing trace amounts of one or two or more rare earth metal elements selected from the group consisting of Eu, Ce, Pr, Nd, Sm, Tb, Dy, Ho, Er, Tm, Yb, and Lu; CaS containing a trace amount of Bi; CaSrS containing a trace amount of Bi; ZnS containing a trace amount of Cu; and ZnCdS containing a trace amount of Cu. Thus, the luminescent glass article can emit light for a long period of time, anda luminescence intensity 10 min after the irradiation is 10% or more of the initial luminescence intensity.

The luminescent glass article of the present invention may employ a luminescent substance having an average particle size of 0.1 to 5,000 μm, and particularly preferably 50 to 5,000 μm. If the average particle size is less than 0.1 μm, the surface of the luminescent substance deteriorates due to heat applied for uniform dispersion of the luminescent substance in the glass, thereby resulting in a reduction of luminescence intensity. If the average particle size is more than 5,000 μm, glass fusion is liable to be inhibited. The average particle size is preferably 75 to 4,500 μm, and more preferably 100 to 4,000 μm.

In particular, if the average particle size of the luminescent substance is more than 50 μm, the surface of the luminescent substance may deteriorate, but inside thereof is not deteriorated. Thus, the ratio of the luminescent substance to be deteriorated is reduced, and the number of particles is smaller than that in a case where the average particle size is small, to thereby easily provide light transmittance and high luminescence intensity.

The luminescent glass article of the present invention exhibits the color of a luminescent substance itself in a bright place, and exhibits the color of the glass article due to its light transmission when it is irradiated with light from a back surface. Meanwhile, the luminescent glass article exhibits a luminescent color in a dark place specific to the luminescent substance itself. The luminescent glass article has three different appearances according to brightness and thus can be appropriately designed.

The luminescent glass article of the present invention preferably has 100 or less bubbles per 1 cm³. If the luminescent glass article has more than 100 bubbles, light is scattered by bubbles and the light barely reaches the luminescent substance. Thus, luminescence intensity is hardly enhanced, and its mechanical strength is liable to be weak. As well, the bubbles refer to those each having a diameter of 0.01 mm or more.

The luminescent glass article of the present invention can be formed into a block or plate having a thickness of 5 to 100 mm. If the luminescent glass article has a thickness of less than 5 mm, an amount of the luminescent substance present per unit area is small, and thus sufficient luminescence intensity is difficult to obtain. If the luminescent glass article has a thickness of more than 100 mm, internal strain increases, and mechanical strength is liable to be weak. The thickness of the luminescent glass article is increased to raise the amount of the luminescent substance present per unit area of a design area, and thus the luminescence intensity is liable to increase. As described above, the glass article of the present invention formed into a plate has high mechanical strength and light transmission, and thus can be used as a part of the lighting design.

The luminescent glass article of the present invention includes the luminescent substance uniformly dispersed in glass. Thus, even if the luminescent glass article is cut, the cut surface has the same appearance as those of other surfaces. Thus, the luminescent glass article can be subjected to cutting or engraving.

Next, a description of the method of manufacturing the luminescent glass article of the present invention will be given.

First, a plurality of glass particles, the luminescent substance, and as required, an adhesive and/or colorant are added and mixed uniformly. The mixture is poured into a refractory vessel having alumina powder and/or ceramic fiber sheet formed on an inner surface thereof. Then, the whole is subjected to heat treatment between 800 and 1,200° C. for 1 to 10 hours, to thereby manufacture the luminescent glass article.

The glass particles have an average particle size of 0.1 to 50 mm, preferably 0.3 to 30 mm, and more preferably 0.5 to 10 mm. If the average particle size is more than 50 mm, the glass article is liable to include large bubbles and thereby weaken the mechanical strength. If the average particle size is less than 0.1 mm, a manufacturing cost increases and the number of bubbles per 1 cm³ is liable to exceed 100. The glass particles in the form of sheets, rod, or beads may be used.

Glass particles obtained by grinding a block of glass or ceramics containing a luminescent substance may be mixed with particles of glass or ceramics without a luminescent substance.

The refractory vessel is preferably formed of a material which does not soften or deform even at 1,200° C. Examples of such a material that can be used include mullite, cordierite, and alumina ceramic. A ceramic fiber sheet or powder containing as a main component silica, alumina, or zirconia is provided or applied as a release agent onto an inner surface of the refractory vessel.

The heat treatment is preferably performed in an inert atmosphere such as nitrogen gas or argon gas because the luminescent substance is difficult to oxidize and the luminescence intensity hardly degrades.

### EXAMPLES

Hereinafter, the present invention will be described in detail based on examples.

Table 1 shows luminescent glass articles of the present invention (Examples 1 to 6), and Table 2 shows luminescent glass articles of the present invention (Examples 7 to 10) and comparative examples of a luminescent glass article is shown.

TABLE 1

| | | Example 1 | Example 2 | Example 3 | Example 4 | Example 5 | Example 6 |
|---|---|---|---|---|---|---|---|
| Glass softening point (° C.) | | 720 | 740 | 720 | 740 | 740 | 740 |
| Treatment temperature (° C.) | | 850 | 900 | 850 | 900 | 900 | 900 |
| Content of luminescent substance (mass %) | | 2.5 | 2.5 | 2.5 | 2.5 | 2.5 | 2.5 |
| Fluidity | | ∘ | ∘ | ∘ | ∘ | ∘ | ∘ |
| Light transmittance (%) | | 21 | 25 | 22 | 25 | 48 | 50 |
| Luminescent color | | Blue | Blue | Orange | Orange | Blue | Blue |
| | | green | green | | | green | green |
| Initial luminescence intensity (mcd/m²) | | 320 | 300 | 250 | 220 | 450 | 440 |
| Luminescence intensity 10 | | 76 | 67 | 38 | 27 | 109 | 97 |
| min after irradiation (mcd/m²) | | | | | | | |
| Luminescence intensity ratio (%) | | 24 | 22 | 15 | 12 | 24 | 22 |
| Visual observation | | ∘ | ∘ | ∘ | ∘ | ∘ | ∘ |
| Mechanical strength (MPa) | | 25 | 30 | 25 | 30 | 28 | 30 |
| Chemical | Acid resistance | 0.7 | 0.5 | 0.8 | 0.6 | 0.6 | 0.5 |
| resistance (mg/cm²) | Alkali resistance | 1.1 | 0.9 | 1.2 | 0.9 | 1.0 | 0.9 |

TABLE 2

| | | | | | | Comparative |
|---|---|---|---|---|---|---|
| | | Example 7 | Example 8 | Example 9 | Example 10 | Example |
| Glass softening point (° C.) | | 740 | 740 | 740 | 740 | 720 |
| Treatment temperature (° C.) | | 900 | 900 | 900 | 900 | 850 |
| Content of luminescent substance (mass %) | | 2.5 | 2.5 | 2.5 | 2.5 | 20 |
| Fluidity | | ∘ | ∘ | ∘ | ∘ | x |
| Light transmittance (%) | | 51 | 50 | 52 | 50 | 5 |
| Luminescent color | | Yellow | Yellow | Blue | Blue | Blue |
| | | green | green | green | green | green |
| Initial luminescence intensity (mcd/m²) | | 435 | 445 | 420 | 350 | 450 |
| Luminescence intensity 10 min | | 89 | 90 | 90 | 67 | 99 |
| after irradiation (mcd/m²) | | | | | | |
| Luminescence intensity ratio (%) | | 20 | 20 | 21 | 19 | 22 |
| Visual observation | | ∘ | ∘ | ∘ | ∘ | ∘ |
| Mechanical strength (MPa) | | 27 | 30 | 27 | 30 | 15 |
| Chemical | Acid resistance | 0.7 | 0.6 | 0.5 | 0.6 | 0.7 |
| resistance (mg/cm²) | Alkali resistance | 1.1 | 0.9 | 0.9 | 1.0 | 1.3 |

### Example 1

Soda-lime glass having a composition of 70.0% SiO₂, 2.0% Al₂O₃, 4.0% B₂O₃, 2.0% MgO, 7.0% CaO, 14.0% Na₂O, and 1.0% K₂O in mass % was ground into a size of 0.5 to 2 mm and classified, to thereby prepare glass particles (A) having an average particle size of 0.6 mm.

Next, 21 g of a luminescent substance containing small amounts of Eu²⁺ and Dy³⁺ in Sr₄Al₁₄O₂₅ (ULTRA GLOW NP-2820, average particle size of 20 μm, available from Nichia Corporation), and 9 g of an acryl/alkylstyrene-based organic binder as an adhesive were added to 813 g of the glass particles (A). The mixture was stirred for 30 min, filled into a refractory ceramic vessel, and subjected to heat treatment in a nitrogen atmosphere at 850° C. for 3 hours, to thereby manufacture a luminescent glass article of 196×96×18 mm.

The refractory ceramic vessel had an inner size of 200×100×150 mm and was formed of cordierite. Alumina powder was applied onto an inner surface of the vessel, and a ceramic fiber sheet having a composition of 95 mass % silica and 5 mass % alumina was placed on a base of the vessel.

### Example 2

Borosilicate glass having a composition of 70.2% SiO₂, 5.4% Al₂O₃, 13.5% B₂O₃, 0.5% CaO, 6.7% Na₂O, and 2.2% K₂O in mass % was ground into a size of 0.5 to 2 mm and classified, to thereby prepare glass particles (B) having an average particle size of 0.6 mm.

Then, a luminescent glass article was manufactured in the same manner as in Example 1 except that: 779 g of the glass particles (B), 20 g of a luminescent substance (ULTRA GLOW NP-2820, average particle size of 20 μm, available from Nichia Corporation), and 8 g of an acryl/alkylstyrene-based organic binder were used; and the mixture was subjected to heat treatment at 900° C.

### Example 3

A luminescent glass article was manufactured in the same manner as in Example 1 except that 21 g of a luminescent substance containing small amounts of Eu²⁺, Dy³⁺, Ti⁴⁺, and Mg²⁺ in Y₂O₂S (ULTRA GLOW NP-2850, average particle size of 30 μm, available from Nichia Corporation) was used.

### Example 4

A luminescent glass article was manufactured in the same manner as in Example 2 except that 20 g of a luminescent substance containing small amounts of Eu²⁺, Dy³⁺, Ti⁴⁺, and Mg²⁺ in Y₂O₂S (ULTRA GLOW NP-2850, average particle size of 30 μm, available from Nichia Corporation) was used.

### Example 5

A luminescent glass article was manufactured in the same manner as in Example 2 except that: 20 g of a luminescent substance containing small amounts of Eu²⁺ and Dy³⁺ in SrAl₂O₄ (α-FLASH PB500, average particle size of 500 μm, available from LTI Corporation) was used; and the mixture was subjected to heat treatment in atmospheric air.

### Example 6

A luminescent substance of 67 g containing small amounts of Eu²⁺ and Dy³⁺ in SrAl₂O₄ (α-FLASH PB500, average particle size of 500 μm, available from LTI Corporation) and 27 g of an acryl/alkylstyrene-based organic binder were added to 2,608 g of the glass particles (B). The mixture was stirred for 30 min, poured into a refractory ceramic vessel, and subjected to heat treatment in atmospheric air at 900° C. for 3 hours, to thereby manufacture a luminescent glass article of 196×96×60 mm.

### Example 7

A luminescent glass article was manufactured in the same manner as in Example 5 except that 20 g of a luminescent substance containing small amounts of Eu²⁺ and Dy³⁺ in SrAl₂O₄ (α-FLASH PB500, average particle size of 500 μm, available from LTI Corporation) was used.

### Example 8

A luminescent glass article was manufactured in the same manner as in Example 6 except that 67 g of a luminescent substance containing small amounts of Eu²⁺ and Dy³⁺ in SrAl₂O₄ (α-FLASH PB500, average particle size of 500 μm, available from LTI Corporation) was used.

### Example 9

Borosilicate glass having a composition of 70.2% SiO₂, 5.4% Al₂O₃, 13.5% B₂O₃, 0.5% CaO, 6.7% Na₂O, and 2.2% K₂O in mass % was ground into a size of 2 to 5 mm and classified by particle, to thereby prepare glass particles (C) having an average particle size of 3.0 mm.

Next, 56 g of a luminescent substance containing small amounts of Eu²⁺ and Dy³⁺ in SrAl₂O₄ (α-FLASH PB500, average particle size of 500 μm, available from LTI Corporation) and 22 g of an acryl/alkylstyrene-based organic binder were added to 2,189 g of the glass particles (C). The mixture was subjected to heat treatment in atmospheric air at 900° C. for 3 hours, to thereby manufacture a luminescent glass article of 196×96×50 mm.

### Example 10

A luminescent glass article was manufactured in the same manner as in Example 9 except that a luminescent substance containing trace amounts of Eu²⁺ and Dy³⁺ in SrAl₂O₄ (LumiNova BGL, average particle size of 500 μm, available from Nemoto & Co., Ltd.) was used.

### Comparative Example

A luminescent glass article was manufactured in the same manner as in Example 1 except that 203 g of a luminescent substance containing small amounts of Eu²⁺ and Dy³⁺ in Sr₄Al₁₄O₂₅ (ULTRA GLOW NP-2820, average particle size of 20 μm, available from Nichia Corporation) was used.

A glass softening point was measured by using a macro-type differential thermal analyzer (manufactured by Rigaku Corporation), and a temperature of the obtained fourth inflection point was regarded as the softening point.

Fluidity was determined through visual observation of a sample surface after heat treatment. A sample having a smooth and glossy surface was represented by “o”, and a sample having a rough and dull surface was represented by “×”. A luminescent color was determined through visual observation in a dark place.

A light transmittance refers to a value obtained by: cutting a luminescent glass article into a size of 50×50×10 mm; subjecting both surfaces of the cut-out piece to optical polishing to prepare a plate sample; adjusting light directly illuminated from a light source of a fluorescent lamp to an illuminance meter (LX-1334, manufactured by Custom K.K.) at an illuminance of 1,000 lux; measuring an illuminance (lux) 10 times with the sample placed between the fluorescent lamp and the illuminance meter; and dividing an average value thereof by 1,000 lux and multiplying the quotient by 100.

The luminescent color was determined through visual observation in a dark place.

The luminescence intensity was determined by: cutting a luminescent glass article into a size of 50×50×10 mm; subjecting both surfaces of the cut-out piece to optical polishing to prepare a plate sample; leaving the sample standing in a dark place for 8 hours; irradiating light of 1,000 lux for 20 min; measuring an luminescence at 10 positions each just after the irradiation or 10 min after the irradiation by using a illuminance meter (LS-100, manufactured by Konica Minolta Holdings, Inc.); and obtaining the respective average values.

Visual observation was performed by: cutting a luminescent glass article into a size of 50×50×10 mm; subjecting both surfaces of the cut-out piece to optical polishing to prepare a plate sample; leaving the sample standing in a dark place for 8 hours; irradiating light of 1,000 lux for 20 min; and visually observing the sample 1 hour after the irradiation, to thereby determine whether the sample emitted light or not.

Mechanical strength was measured by: cutting a sample into a size of 10×70×8 (mm); and performing a three-point bending test by using a bending tester (EZTest-500N, manufactured by Shimadzu Corporation) at a distance between supports of 30 mm and a crosshead speed of 0.5 mm/min.

Chemical resistance was evaluated by determining acid resistance and alkali resistance. The chemical resistance was determined by: cutting a sample into a size of 25×25×5 (mm); subjecting the sample surface to mirror polishing; measuring a reduced amount of mass of the sample immersed in a 1% sulfuric acid solution for acid resistance or a 1% sodium hydroxide solution for alkali resistance at 90° C. for 24 hours; and calculating the reduced amount per surface area.

Luminescent glass articles of Examples 1 to 10 each had a light transmittance of 20% or more, an initial luminescence intensity of 200 mcd/mm² or more, and an luminescence intensity 10 min after the irradiation of 12% or more of the initial luminescence intensity. The luminescent glass articles each had a luminescence intensity that can be sufficiently confirmed through visual observation. In particular, the luminescent glass articles of Examples 5 to 10 each had a light transmittance of 48% or more, an initial luminescence intensity of 350 mcd/mm² or more, and an luminescence intensity 10 min after the irradiation of 19% or more of the initial luminescence intensity.

Luminescent glass articles of Examples 1 to 10 all had good fluidity, high mechanical strength of 25 MPa or more, and chemical resistance including acid resistance of 0.8 mg/cm² or less and alkali resistance of 1.2 mg/cm² or less.

Meanwhile, the luminescent glass article of the Comparative Example had poor fluidity and a low mechanical strength of 15 MPa. Although the luminescent glass article of the Comparative Example had a larger content of the luminescent substance than those of the luminescent glass articles of Examples 5 to 10, the luminescent glass article of the Comparative Example had initial luminescence intensity. The luminescence intensity 10 minutes after the irradiation was comparable to those of the luminescent glass articles of Examples 5 to 10.

### INDUSTRIAL APPLICABILITY

As described above, the luminescent glass article of the present invention has high mechanical strength, can provide sufficient luminescence intensity, and can be manufactured at low cost. Further, the luminescent glass article itself emits light without turning on illumination, to thereby allow easy recognition of a wall or step and prevention of an accident, such as collision or falling. Therefore, the luminescent glass article of the present invention is suitable for pavements, building covering materials building interior materials, art objects, guide lights, sidewalk lights, foot lights, window members, and the like.

1. A luminescent glass article, characterized by comprising a luminescent substance dispersed uniformly in glass, wherein:
light transmittance is 20 to 90% at a thickness of 10 mm; and
an initial luminescence intensity just after irradiation of light of 1,000 lux for 20 min is 200 to 4,000 mcd/m².

2. A luminescent glass article according to claim 1, characterized in that a luminescence intensity 10 min after the irradiation, is 10% or more of the initial luminescence intensity.

3. A luminescent glass article according to claim 1, characterized in that a content of the luminescent substance, is 0.1 to 5 mass %.

4. A luminescent glass article, characterized by comprising a luminescent substance dispersed uniformly in glass, wherein the content of the luminescent substance is 0.1 to 5 mass %.

5. A luminescent glass article, according to claim 4, characterized in that the glass, has a softening point of 650 to 1,100° C.

6. A luminescent glass article according to claim 5, characterized in that the glass, is composed of one type or two or more types of glass selected from the group consisting of soda-lime glass, borosilicate glass, aluminosilicate glass, and aluminoborosilicate glass.

7. A luminescent glass article according to claim 4, characterized in that the luminescent substance, has an average particle size of 50 to 5,000 μm.

8. A luminescent glass article according to claim 4, characterized in that the luminescent glass article, is formed into a block or plate having a thickness of 5 to 100 mm.

9. A method of manufacturing a luminescent glass article, characterized by comprising:
mixing a plurality of glass particles and a luminescent substance;
pouring the mixture into a refractory vessel; and
subjecting the mixture to heat treatment for sintering.

10. A luminescent glass article, according to claim 1, characterized in that the glass, has a softening point of 650 to 1,100° C.

11. A luminescent glass article according to claim 10, characterized in that the glass, is composed of one type or two or more types of glass selected from the group consisting of soda-lime glass, borosilicate glass, aluminosilicate glass, and aluminoborosilicate glass.
